(19) United States
(12) Patent Application Publication
(10) Pub. No.: US 2009/0129795 A1
(43) Pub. Date: May 21, 2009

(54) COLOR IMAGE FORMING METHOD AND COLOR IMAGE FORMING APPARATUS

(75) Inventor: Shoko Shimmura, Kanagawa (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/255,357

(22) Filed: Oct. 21, 2008

Related U.S. Application Data
(60) Provisional application No. 60/988,367, filed on Nov. 15, 2007.

(51) Int. Cl. G03G 15/00

(52) U.S. Cl. 399/39

(57) ABSTRACT

Plural image forming sections transfer toner images of plural colors to a transfer target medium, so that a color image is formed on the transfer target medium. When a weight per particle of respective monochromatic toner particles calculated from a 50% volume average particle diameter of the respective monochromatic toner particles is m (kg), a charge amount per particle of the respective monochromatic toner particles calculated from a charge amount Q/M (C/kg) per weight measured by a suction type particle charge amount measuring device is q (C), and an average adhesive force between each of the monochromatic toner particles and each of the image carriers is F (N), F/q of the toner particle used in the image forming section in which order in transferring the monochromatic toner image to the transfer target medium is the first in the plural image forming sections is largest.

### CROSS-REFERENCE TO RELATED APPLICATION

The present application claims priority under 35 U.S.C. 119 to U.S. Provisional Application Ser. No. 60/988,367, entitled Color Image Forming Method and Color Image Forming Apparatus, to Shimmura, filed on Nov. 15, 2007, the entire disclosure of which is incorporated herein by reference.

### TECHNICAL FIELD

The present invention relates to a color image forming method and a color image forming apparatus.

### BACKGROUND

For the purpose of outputting a color image at high speed, a tandem structure is advantageous in which plural image forming stations are sequentially arranged over a transfer medium, and a full color image is obtained through one path. The transfer medium is usually belt-shaped. An image forming apparatus superposes and transfers toner images developed on a latent image carrier onto the transfer medium for respective colors.

A transfer member such as a transfer roller is disposed at a position opposite to the latent image carrier through the transfer medium. Toner is transferred from the latent image carrier to the transfer member at a transfer nip as a transfer position where the latent image carrier and the transfer member contact with each other. A voltage is applied to the transfer member so that a transfer electric field is generated. The toner on the latent image carrier is transferred to the transfer member by the transfer electric field. At the transfer, in order to prevent a transfer bias current from flowing on the surface of the transfer member in a direction other than the direction toward the transfer nip, the image forming apparatus uses a semi-conductive belt having a rather high electric resistance as the transfer medium (in a direct transfer system, the transfer medium is a final transfer medium (paper or the like). In an intermediate transfer system, the transfer medium is an intermediate transfer belt).

In general, when the image forming apparatus uses the semi-conductive belt to multiple-transfer toner images, an electric charge is accumulated on the semi-conductive belt. As the order of the image forming unit disposed along the conveyance direction becomes more downstream, the transfer electric field becomes small, and defective transfer occurs. The tendency that the defective transfer is more likely to occur in the downstream station becomes a serious problem since a printing apparatus is miniaturized in recent years and the speed-up of the process is increased.

Since a transfer time is short, a high voltage is required to obtain a sufficient transfer electric field. An interval between adjacent transfer nips becomes short by the miniaturization of the apparatus. There is no room where the accumulated electric charge is discharged.

Hitherto, an image forming apparatus is proposed in which a transfer bias is set to become sequentially higher (for example, JP-A-06-230686). The image forming apparatus disclosed in JP-A-06-230686 includes plural transfer units, and voltage applying units to apply bias voltages to the transfer units so that an electric field formed between a conveyance unit and each of the transfer units becomes large for the transfer unit located on a more downstream side along the conveyance unit.

Besides, as a technique to solve the defective transfer without increasing the transfer voltage, an image forming apparatus is proposed in which an amount, a value or a potential other than the transfer bias is sequentially changed (for example, JP-A-08-106197). In the image forming apparatus disclosed in JP-A-08-106197, the amount of tribo-electric charge (amount of friction electric charge) of toner of each developer, the volume intrinsic resistance value of each developer, or the charging potential of an image carrier when an electrostatic latent image corresponding to each developer image is formed is reduced according to the order of transfer.

An image forming apparatus is also proposed in which roller resistance is sequentially changed while a transfer bias is constant (for example, JP-A-09-50197). The image forming apparatus disclosed in JP-A-09-50197 includes a conveyance unit, and plural transfer units which have specified resistance values determined so that the resistance values are gradually reduced in accordance with the arrangement order of respective image carriers and transfer respective developer images to a transfer member. The image forming apparatus uses only a pair of transfer voltage application devices and efficiently transfers plural images.

However, in the technique disclosed in JP-A-06-230686, a voltage required for a downstream image forming unit becomes large, and the capacity of a power source is increased and the cost is increased. Besides, the toner previously transferred to a sheet is likely to be reversely transferred in a region where all colors at latter stages are transferred to the sheet. Each time the sheet passes the transfer nip, electric discharge occurs and the amount of electric charge on the sheet is increased or decreased. A difference between the charge amount of previously transferred toner and the charge amount of later transferred toner is large. The optimum electric field of secondary transfer varies according to a color or a combination of colors of superposed toners. As a result, there is a problem that the amount of transfer residual toner after the secondary transfer becomes large.

In the technique disclosed in JP-A-08-106197, each time the transferred toner passes the transfer nip, at one of or both of an outlet of the nip and an inlet of the nip, the toner electric charge is increased or decreased by the electric discharge generated between the toner and a photoconductor. Since a difference of the charge amounts is large for each color, it is difficult to uniformly perform the secondary transfer. In order to uniformly and stably obtain a developing property (development easiness of toner) for each color, it is not desirable to change the charge potential of the latent image carrier.

JP-A-09-50197 discloses that the resistance value of the material of the transfer belt is larger than the resistance value of the material of the transfer roller, and the surface resistance of the conveyance belt and the volume resistance are not influenced by the environmental condition. In the technique disclosed in JP-A-09-50197, it is difficult to give a change of the resistance value to cancel charge-up of the conveyance belt to the transfer rollers. When the transfer roller having a high volume resistance is used as the upstream transfer roller, a large application voltage is required, and the capacity of a power source is increased and the cost is increased.

### SUMMARY

In an aspect of the present invention, a color image forming apparatus includes plural image carriers, plural toner image forming sections each of which forms a monochromatic toner image on each of the image carriers by using monochromatic toner particles, plural transfer sections each of which transfers the monochromatic toner image formed on each of the image carriers to a transfer target medium, a bias voltage application section to apply to each of the transfer sections a bias voltage of a polarity for exerting a force to the respective toner particles in a direction from each of the image carriers to the transfer target medium, and a conveyance section to convey the transfer target medium along an arrangement direction of the plural image forming units, and when a weight per particle of the respective monochromatic toner particles calculated from a 50% volume average particle diameter of the respective monochromatic toner particles is m (kg), a charge amount per particle of the respective monochromatic toner particles calculated from a charge amount Q/M (C/kg) per weight measured by a suction type particle charge amount measuring device is q (C), and an average adhesive force between each of the monochromatic toner particles and each of the image carriers is F (N), the transfer section of the plural transfer sections positioned at the most upstream side in the arrangement direction transfers a toner particle having largest F/q in the toner particles of plural colors to the transfer target medium.

### DESCRIPTION OF THE DRAWINGS

FIG. 1A is a perspective view showing a sample set for measuring an average adhesive force of toner particles;

FIG. 1B is a sectional view showing a cell for measuring the average adhesive force of the toner particles;

FIG. 2A is a perspective view of an angle rotor;

FIG. 2B is a longitudinal sectional view partially showing a section of the angle rotor along a rotor rotation shaft;

FIG. 3 is a schematic structural view of an image forming apparatus based on a two-component development process;

FIG. 4 is a schematic structural view of an image forming apparatus based on a cleanerless process;

FIG. 5A is a schematic structural view of a tandem image forming apparatus based on a four-drum tandem process;

FIG. 5B is a schematic structural view of another tandem image forming apparatus based on a four-drum tandem process; and

FIG. 6 is a schematic structural view of an image forming apparatus based on a four-drum tandem cleanerless process.

### DETAILED DESCRIPTION

Throughout this description, the embodiments and examples shown should be considered as exemplars, rather than limitations on the apparatus and methods of the present invention.

Hereinafter, a color image forming method and a color image forming apparatus will be described in detail with reference to the accompanying drawings. Incidentally, in the respective drawings, the same portions are denoted by the same reference numerals and their duplicate description will be omitted.

An average adhesive force between a toner particle and a conveyance medium is obtained by the sum of an electrostatic adhesive force of the toner particle to the conveyance medium and a non-electrostatic adhesive force of the toner particle to the conveyance medium. The average adhesive force is measured as described below by using a super centrifugal machine for separation (CP100MX) made by Hitachi Koki, an angle rotor (AngleRotor P100AT2) and a cell produced for measurement of powder adhesive force.

### (Measurement Method of Average Adhesive Force)

(1) A sheet is formed in which a surface protection layer equivalent to a conveyance medium as an object on which an adhesive force is measured is formed on a surface. In order to measure the adhesive force to a photoconductor, a photoconductive sheet is formed. In order to measure the adhesive force to an intermediate transfer belt, a sheet equivalent to the belt material is formed. In order to measure the adhesive force, it is desirable that the surface protection layer is equivalent to the conveyance medium. A difference in the adhesive force caused by the material of the adhesion object is small as compared with a difference in the adhesive force caused by the shape (surface roughness, etc.) of the object, a toner charge amount, environmental temperature and humidity, and the like. It is unnecessary that the surface protection layer and the conveyance medium are exactly the same material.

In order to reproduce toner adhesion to the photoconductor, a CGL (Charge Generation Layer) layer and a CTL (Charge Transfer Layer) layer may be laminated similarly to the photoconductor. The sheet is wound around an aluminum element tube. A photoconductive layer is grounded to GND. The sheet is set at a position of a photoconductive drum. Similarly to the image formation, the toner is developed and adhered to the surface of the sheet. Alternatively, the toner is transferred to the sheet having the same material as the intermediate transfer belt.

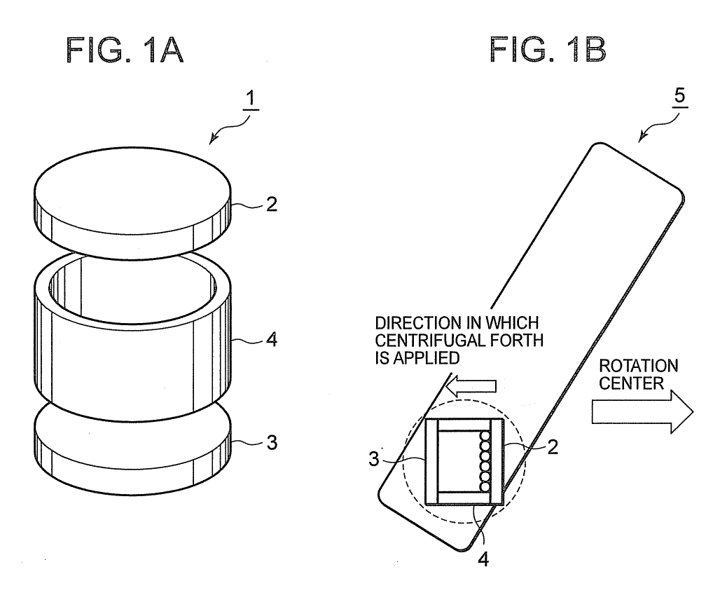

(2) The sheet to which the toner is adhered is placed in a sample set. FIG. 1A is a perspective view showing a sample set for measuring the average adhesive force of toner particles. A sample set 1 includes a plate A2, a plate B3 and a spacer 4. The sheet to which the toner is adhered is cut into a size of the plate A2. The sheet is adhered to the surface of the plate A2 at the side facing the spacer 4 by a double-sided tape.

(3) The diameter of the outer periphery of each of the plate A2, the plate B3, and the spacer 4 is 7 mm. The thickness of the spacer 4 having a cylindrical shape is 1 mm, and the height is 3 mm. FIG. 1B is a sectional view showing a cell for measuring the average adhesive force of the toner particles. The components in a dotted line correspond to the components of FIG. 1A. The position of the plate A2 shown in FIG. 1B is the position where the sample to which the powder is adhered is set. The plate B3 indicates a receiving plate to which the powder separated by the centrifugal force adheres.

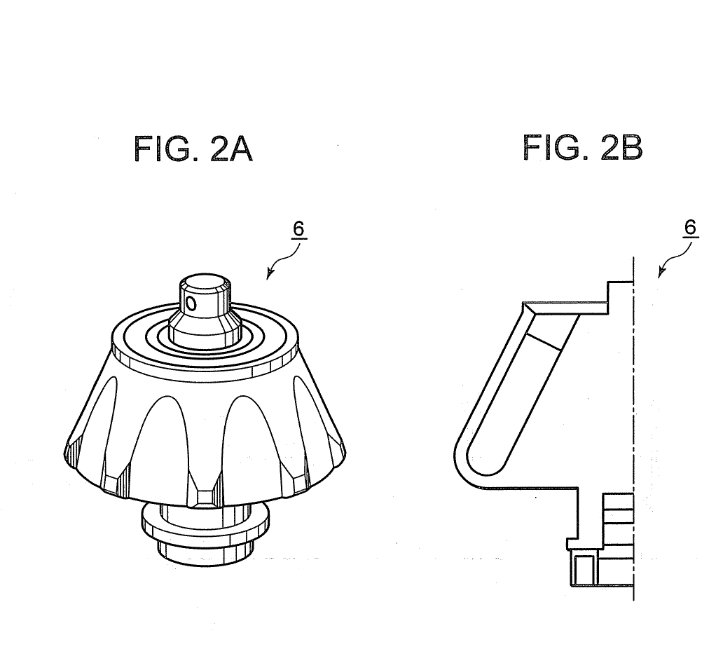

The plate A2, the spacer 4, and the plate B3 are set in a cell 5 in the order of the plate A2, the spacer 4 and the plate B3 so that the surface of the plate A2 opposite to the surface of the plate A2 to which the sample is adhered is directed to the rotation center. The cell 5 is set in an angle rotor 6. FIG. 2A is a perspective view of the angle rotor 6. FIG. 2B is a longitudinal sectional view partially showing the section of the angle rotor 6 along a rotor rotation shaft. The angle rotor 6 is mounted to a not-shown super centrifugal machine.

(4) After the super centrifugal machine rotates at 10000 rpm, the plate A2 and the plate B3 are taken out. The toner particles adhered to the plate A2 and the plate B3 are separated by a mending tape, and the separated toner particles are adhered to a white paper. The reflection density of the tape to which the toner is adhered is measured by a Macbeth densitometer.

(5) A calibration expression of taping density and a toner amount is formed separately. The amount of separated toner and the amount of toner not separated are calculated from the calibration expression.

(6) The sheet to which the toner is adhered is cut similarly to the above paragraph (2). The cut sheet is adhered to the plate A2. The plate A2, the plate B3 and the spacer 4 are set in the super centrifugal machine similarly to the paragraph (3). After the super centrifugal machine rotates at 20000 rpm, the cell is taken out. The amounts of toner adhered to the plate A2 and the plate B3 are measured. This operation is repeated for every 10,000 rpm up to 100,000 rpm.

(7) The centrifugal force F applied to the toner at each rotation number is expressed by an expression of F=RCF×m. The character RCF denotes centrifugal acceleration which is received by the sample set in the cell by the rotation of the rotor. The character m denotes the weight of one toner particle. The expression of F=RCF×m is multiplied by a separation toner ratio at each rotation number, and a value obtained by adding all obtained results is the average adhesive force between the toner in the developer used for the measurement and the photoconductor.

The adhesive force is greatly influenced by the charge amount of toner. In order to perform measurement with high accuracy, it is desirable to form a measurement sample by an adhesion method in conformity with an actual process.

### (Electrophotographic Development Process)

An image is formed by a development process described below.

The toner includes a binder resin (polyester resin, styrene-acrylic resin, cyclic olefin resin, etc.), a coloring agent (pigment or dye well-known in this technical field, such as carbon black, condensed polycyclic pigment, azo pigment, phthalocyanine pigment, or inorganic pigment), wax (polyethylene system, polypropylene system, carnauba, rice, paraffin, etc.) as a fixing assistant agent, a charge control agent (CCA) and the like.

In addition, the toner has a well-known composition, for example, an inorganic fine particle (silica, alumina, titanium oxide, metal soap, etc.), an organic fine particle or the like is externally added for the purpose of improving flowability and charging property. A mother particle is formed by pulverization or a chemical process. The volume average particle diameter of the mother particle is 3 to 8 μm, and is more desirably 4 to 6 μm.

(1) Two-Component Development

A carrier is a magnetic carrier such as a resin particle in which ferrite, magnetite, iron oxide, or magnetic powder is mixed. A resin coat (fluorine resin, silicone resin, acrylic resin, etc.) may be applied to the whole or part of the surface of the carrier. The volume average particle diameter of the particle is 20 to 100 μm, and is more desirably 30 to 60 μm. In addition, these materials and values can be changed within the range not departing from the gist of the image forming apparatus of the embodiment.

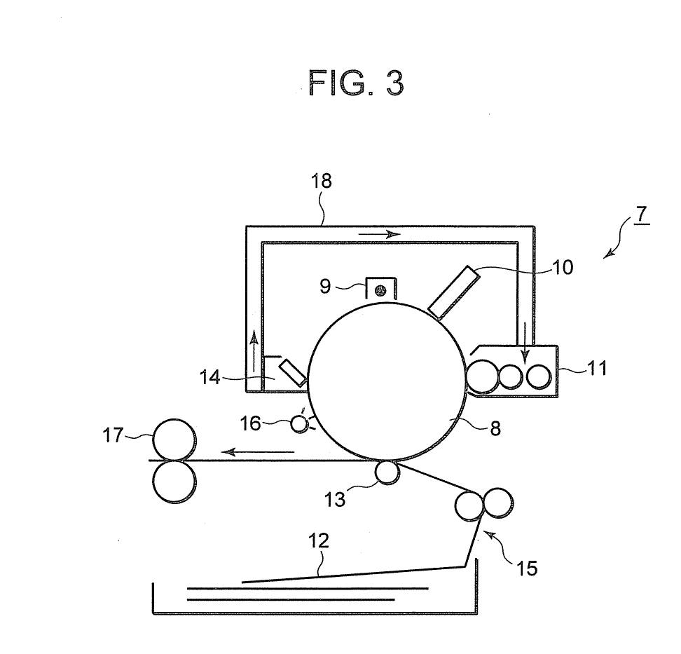

FIG. 3 is a schematic structural view of an image forming apparatus based on a two-component development process. An image forming apparatus 7 includes an image forming unit including an electrostatic latent image carrier 8, a charging device 9 to charge the electrostatic latent image carrier 8, an exposure device 10 to form an electrostatic latent image, a developing section 11 to supply a toner particle to the electrostatic latent image, a transfer device 13 that is provided opposite to the electrostatic latent image carrier 8 and transfers a toner image on the electrostatic latent image carrier 8 onto a transfer medium 12, and a cleaning device 14 to remove a transfer residual toner.

Besides, the image forming apparatus 7 includes a paper feed device 15 to feed the transfer medium 12, a charge removing device 16 to remove the electrostatic latent image on the electrostatic latent image carrier 8, and a fixing section 17 that is provided downstream of a conveyance path and fixes the toner image to the transfer medium 12. In the image forming apparatus 7, a conveyance path 18 is provided from the cleaning device 14 to the developing section 11. A recycle mechanism to collect the residual toner is formed.

1. The charging device 9 charges the electrostatic latent image carrier 8 uniformly to a desired potential. As the charging device 9, a corona charger (charger wire, comb charger, scorotron, etc.), or a non-contact charging device such as a non-contact charging roller is used. Alternatively, as the charging device 9, a contact charging device such as a contact charging roller, a magnetic brush, a conductive brush or a solid charger is used. The electrostatic latent image carrier 8 is a well-known photoconductor such as a positive-charging or a negative-charging OPC (Organic Photoconductor), or amorphous silicon.

The electrostatic latent image carrier 8 may include laminated layers of a charge generation layer, a charge transport layer, a protection layer and the like, or one layer may have plural functions of the charge generation layer, the charge transport layer, the protection layer and the like.

2. The exposure device 10 forms an electrostatic latent image on the electrostatic latent image carrier 8 (belt, roller, etc.) by a well-known exposure member such as a laser, an LED, or a solid head.

3. The developing section 11 supplies a charged toner to the electrostatic latent image on the electrostatic latent image carrier 8 by a magnetic brush phenomenon and makes the image visible. The developing section 11 includes a developer storage container that is connected to the conveyance path 18 and stores a two-component developer, a developing roller containing a mag roller, an agitation auger to convey the two-component developer, and a hopper for toner supply.

The mag roller generates a magnetic brush as a developer carrier. A development bias to form an electric field to cause the development toner to adhere to the electrostatic latent image is applied to the developing roller. The development bias of DC or AC superimposed on DC may be applied to the developing roller so that the toner particles are uniformly and stably adhered to the surface of the photoconductor.

4. The transfer device 13 transfers the toner image to the transfer medium 12 such as a paper through an intermediate transfer body (belt, roller, etc.). Alternatively, the transfer device 13 directly transfers the toner image to the transfer medium 12. As the transfer medium 13, a well-known transfer member such as a transfer roller, a transfer blade, or a corona charger is used.

5. The transfer medium 12 is peeled from the intermediate transfer body or the electrostatic latent image carrier 8 and is conveyed to the fixing section 17. The toner is fixed by a well-known heating and/or pressing fixing system such as a hear roller, and the transfer medium 12 is discharged to the outside of the machine.

6. After the toner image is transferred to the transfer medium 12 through the intermediate transfer body or directly, the cleaning device 14 removes transfer residual toner which is not transferred onto the electrostatic latent image carrier 8 but remains. Besides, the charge removing device 16 erases the electrostatic latent image on the electrostatic latent image carrier 8.

7. The transfer residual toner removed by the cleaning device 14 is sent in the conveyance path 18 by the auger or the like, is stored in a waste toner box, and then is discharged. When a recycle system is used, the transfer residual toner is collected from the conveyance path 18 into the developer storage container of the developing section 11.

8. The developing section 11 contains a two-component developer, made of a carrier and a toner, of 100 g to 700 g in the hopper. When the two-component developer is conveyed to the developing roller by the agitation auger, the magnetic brush supplies the charged toner particles in the two-component developer to the electrostatic latent image carrier 8, and causes them to adhere to the electrostatic latent image. The two-component developer in the developing section 11 loses part of the toner particles by the development. The toner particles not developed are separated from the developing roller at a peeling pole position of the mag roller, and are returned into the developer storage container by the agitation auger.

A well-known toner density sensor is attached to the developer storage container. When the density sensor detects that the toner amount is decreased, a CPU sends a signal to a toner supply hopper and controls so that new toner is replenished. The CPU may control in such a way that toner consumption is estimated by detecting one of or both of the accumulation of print data and the amount of development toner on the photoconductor, and the new toner is replenished based on the toner consumption. Alternatively, the CPU may control by using both the use of the sensor output and the estimation of the consumption.

The CPU may control by using such a system that at the same time as the input of the new toner, a new carrier is also put little by little and the developer is discarded little by little, so that the developer is automatically exchanged. Alternatively, the CPU may control by using such a system that the new carrier is put little by little separately from the input of the new toner, and the developer is discarded little by little, so that the developer is automatically exchanged.

(2) One-Component Development

In a one-component development process, a structure of a developing section is different from the example of the two-component development process.

Only toner particles are stored in the developing section, and a toner image is developed without a carrier. The toner particles are supplied to the surface of the developer carrier by a well-known structure such as a conveyance auger or an intermediate conveyance sponge roller. The toner particles supplied to the surface of the developer carrier are friction charged by a toner charging member of silicone rubber, fluorine rubber, metal blade or the like pressed to the surface of the developer carrier, and are conveyed to a development region as an opposite part to the electrostatic latent image carrier, and the electrostatic latent image is made visible.

The developer carrier is formed of an elastic roller having a conductive rubber layer on a surface. Alternatively, the developer carrier is formed of a metal roller of SUS or the like the surface of which is roughened by sandblast or the like. The electrostatic latent image carrier contacts with and confronts the developer carrier. Alternatively, the electrostatic latent image carrier confronts the developer carrier in a non-contact manner while a regulated gap is provided. The electrostatic latent image carrier rotates at the same peripheral speed as the peripheral speed of the surface of the developer carrier or a peripheral speed different therefrom, so that the toner particles are developed.

In order to assist the adhesion of the toner particles to the electrostatic latent image, a development bias is applied to the developing roller. In order to uniformly and stably adhere the toner particles to the surface of the photoconductor, the development bias of DC or AC superimposed on DC may be applied to the developing roller. Components other than the developing section are the same as the respective components of the case of the two-component development process.

(3) Cleanerless Process

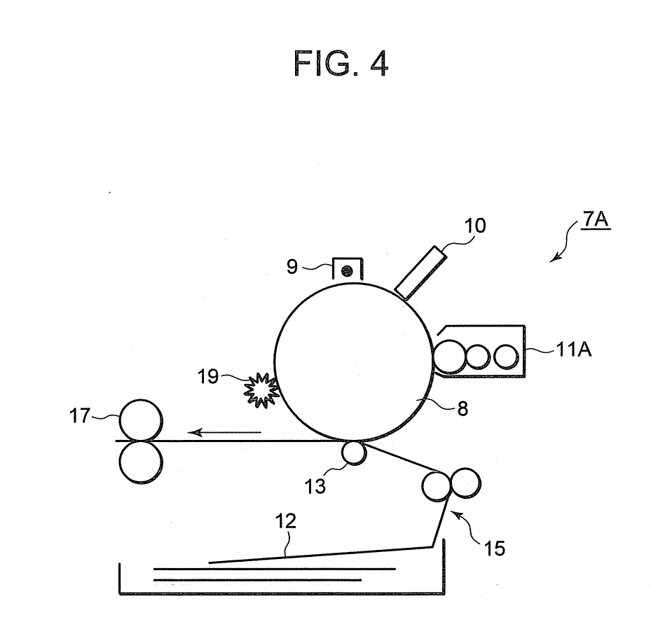

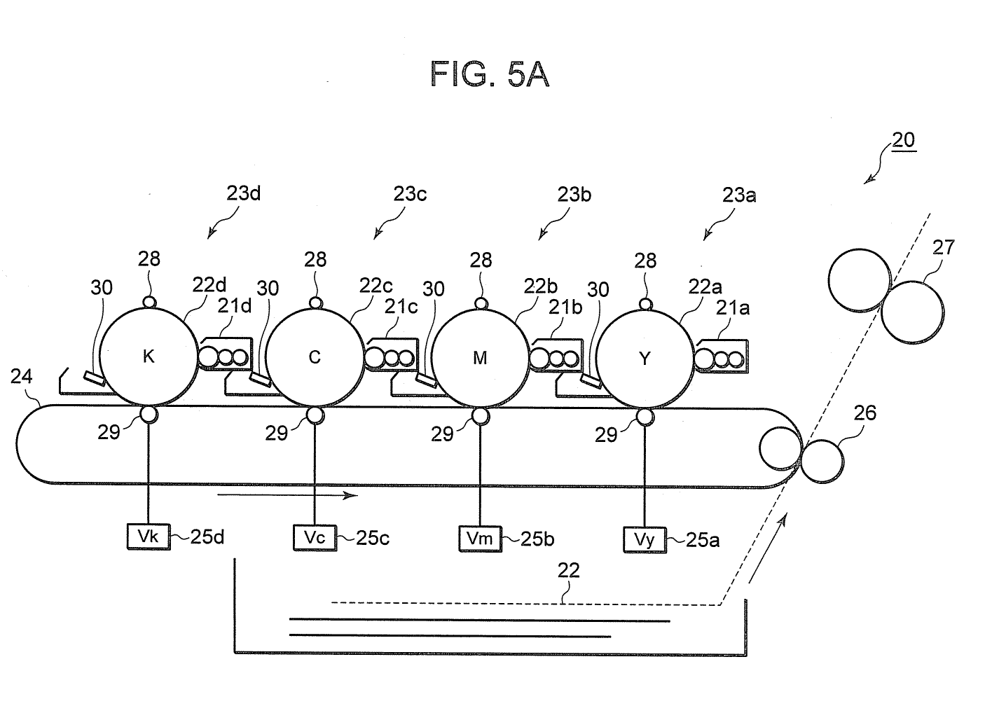

FIG. 4 is a schematic structural view of an image forming apparatus based on a cleanerless process. In the figure, the same reference numerals as those described before denote the same components. An image forming apparatus 7A includes a developing section 11A, instead of the developing section 11, to perform cleaning simultaneously with development. The image forming apparatus 7A has the same structure as that of the image forming apparatus 7 described in the above paragraphs (1) and (2) except that the image forming apparatus 7A does not include the cleaning device 14 and the image forming apparatus 7A uses the development simultaneous cleaning method. A transfer residual toner is collected simultaneously with the development without using a cleaner.

A charging device 9 charges an electrostatic latent image carrier 8. After an exposure device 10 exposes the electrostatic latent image carrier 8, the developing section 11A develops the toner. A transfer device 13 transfers a toner image to a transfer medium 12 through an intermediate transfer medium or directly. After the transfer, a transfer residual toner on the electrostatic latent image carrier 8 is again conveyed to a development region through an image formation step subsequent to the respective steps of charge removal, charging and exposure. A toner remaining in a non-image part of a next image is collected in the developing section 11A by a magnetic brush as a developer carrier.

When a one-component developer is used, the toner is collected onto a developer carrying roller. In the image forming apparatus 7A, a memory disturbing member 19, such as a fixed brush, a felt, a rotation brush or a lateral slide brush, may be disposed at a position before or after an electrostatic latent image on the electrostatic latent image carrier 8 is removed.

Besides, in the image forming apparatus 7A, a temporary collection member is disposed, the residual toner is once collected by using the temporary collection member, and the residual toner is again discharged onto the electrostatic latent image carrier 8, so that the transfer residual toner may be collected in the developing section 11A. Further, in order to adjust the charge amounts of transfer residual toners to a determined value, the image forming apparatus 7A may include a charging device of toner on an electrostatic latent image carrier.

One member may realize part of or all of the functions of the toner charging device, the memory disturbing member, the temporary collection member, and the photoconductor charging member. Besides, in order to efficiently perform the respective functions, one of or both of a plus DC voltage and AC voltage may be applied to the toner charging device, the memory disturbing member, the temporary collection member, and the photoconductor charging member. One of or both of a minus DC voltage and AC voltage may be applied to the toner charging device, the memory disturbing member, the temporary collection member, and the photoconductor charging member.

(4) Four-Drum Tandem Machine

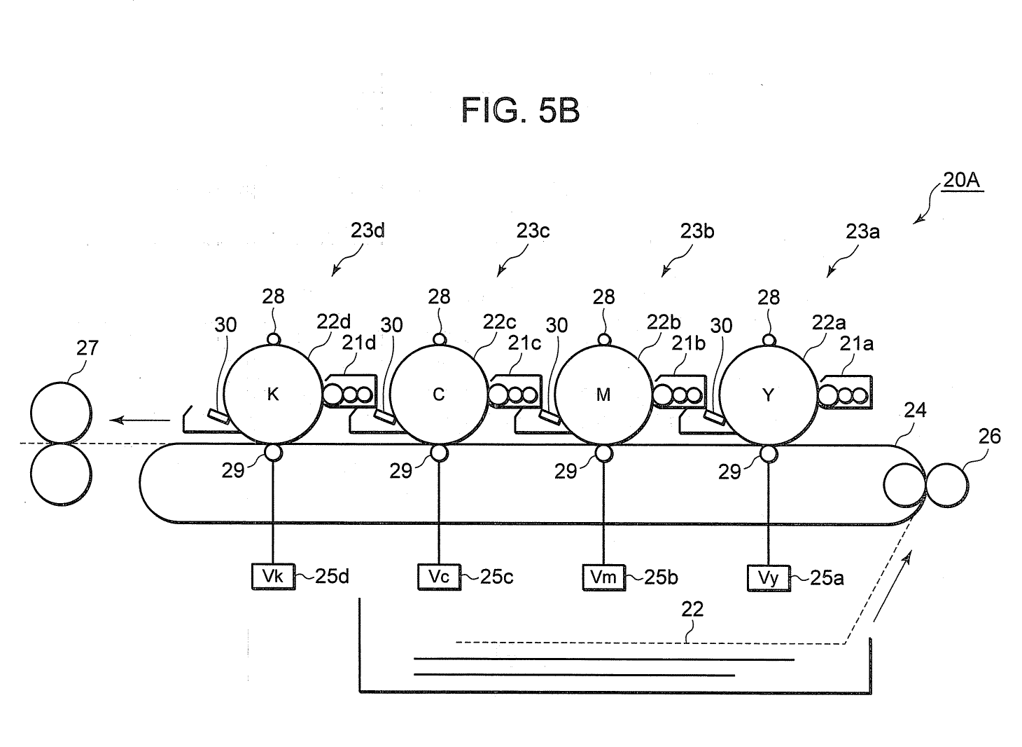

FIG. 5A is a schematic structural view of a tandem image forming apparatus based on a four-drum tandem process. A tandem image forming apparatus 20 is an image forming apparatus using an intermediate transfer system.

The tandem image forming apparatus 20 includes image forming units 23a, 23b, 23c and 23d for four colors, voltage supply sections 25a, 25b, 25c and 25d for supplying transfer bias voltages for the respective colors, a secondary transfer section 26 to transfer toner from an intermediate transfer medium 24 to a paper 22, and a fixing section 27 to fix a toner image to the paper 22. The image forming units 23a to 23d are arranged in parallel along a conveyance path of the intermediate transfer medium 24. A description will be given to an example in which colors are arranged in the order of, for example, yellow, magenta, cyan, and black.

The image forming unit 23a includes an electrostatic latent image carrier 22a, a charging device 28 to charge the electrostatic latent image carrier 22a, a not-shown exposure device to form an electrostatic latent image, a developing section 21a containing a yellow toner, a transfer device 29 to transfer a toner image on the electrostatic latent image carrier 22a to the intermediate transfer medium 24, and a cleaning device 30 to remove a transfer residual toner.

The image forming unit 23b includes an electrostatic latent image carrier 22b, a charging device 28 to charge the electrostatic latent image carrier 22b, a not-shown exposure device, a developing section 21b containing a magenta toner, a transfer device 29 to transfer a toner image on the electrostatic latent image carrier 22b to the intermediate transfer medium 24, and a cleaning device 30.

The image forming unit 23c includes an electrostatic latent image carrier 22c, a charging device 28 to charge the electrostatic latent image carrier 22c, a not-shown exposure device, a developing section 21c containing a cyan toner, a transfer device 29 to transfer a toner image on the electrostatic latent image carrier 22c to the intermediate transfer medium 24, and a cleaning device 30.

The image forming unit 23d includes an electrostatic latent image carrier 22d, a charging device 28 to charge the electrostatic latent image carrier 22d, a not-shown exposure device, a developing section 21d containing a black toner, a transfer device 29 to transfer a toner image on the electrostatic latent image carrier 22d to the intermediate transfer medium 24, and a cleaning device 30.

Besides, an image may be formed on the transfer medium by using a direct transfer system. FIG. 5B is a schematic structural view of a tandem image forming apparatus using a direct transfer system based on the four-drum tandem process. In FIG. 5B, the same reference numerals as those of FIG. 5A denote the same components.

An image is formed through a following process using the tandem image forming apparatus 20 or 20A.

1. As in the above paragraph (1)1 to (1)3, the yellow image forming unit 23a forms an yellow toner image on the electrostatic latent image carrier 22a, and transfers it to the intermediate transfer medium 24. In the direct transfer, the paper 22 or the like as the final transfer medium is conveyed by a conveyance member such as a transfer belt or a roller, and is supplied to the transfer device of the yellow image forming unit 23a.

As the transfer belt, a rubber material such as EPDM (ethylene propylene rubber), CR rubber (chloroprene rubber), or a resin material such as polyimide, polycarbonate, PVDF (Polyvinylidenefluoride), or ETFE (Ethylene Tetrafluoroethylene) is used. It is desirable that the volume intrinsic resistance of the transfer belt is 10⁸ Ωcm to 10¹² Ωcm.

In the intermediate transfer, the belt-like or roller-like intermediate transfer medium 24 is disposed to sequentially pass through the transfer regions of the respective image forming units 23a to 23d. It is desirable that the volume intrinsic resistance of the intermediate transfer belt is 10⁷ Ωcm to 10¹¹ Ωcm. In this example, the volume intrinsic resistance is 10⁹ Ωcm, and the material of the intermediate transfer belt is a rubber material such as EPDM or CR rubber, or a resin material such as polyimide, polycarbonate, PVDF or ETFE. What is obtained by laminating one or two or more layers of a resin sheet, a rubber elastic layer, and a protection layer may be used as the intermediate transfer belt or the transfer belt.

The tandem image forming apparatus 20 or 20A may use another structure within the range not departing from the gist of the image forming apparatus of the embodiment. In the transfer system, a well-known transfer member such as a transfer roller, a transfer blade, or a corona charger can be used.

2. The magenta image forming unit 23b similarly forms a magenta toner image on the electrostatic latent image carrier 22b. The transfer medium (the intermediate transfer medium 24 or the paper 22) on which the yellow toner image is already transferred is supplied to the transfer device of the magenta image forming unit 23b.

The magenta image forming unit 23b aligns positions and transfers the magenta toner image onto the yellow toner image. The yellow toner on the transfer medium contacts with the magenta electrostatic latent image carrier 22b, so that there is a case where a very small part of the yellow toner is reversely transferred to the magenta electrostatic latent image carrier 22b according to the toner charge amount and the intensity of a transfer electric field.

3. Next, the cyan image forming unit 23c and the black image forming unit 23d similarly form toner images. The cyan toner image and the black toner image are sequentially superposed and transferred to the transfer medium.

There is a possibility that a very small part of the former stage toner (yellow and magenta to the cyan electrostatic latent image carrier 22c, yellow, magenta and cyan to the black electrostatic latent image carrier 22d) is reversely transferred to the cyan electrostatic latent image carrier 22c or the black electrostatic latent image carrier 22d.

4. As in the intermediate transfer medium 24, when the transfer medium on which toners of four colors are superposed is the final transfer medium, the transfer medium is separated from the conveyance member, and the transfer medium is conveyed to the fixing section 27. The toner image is fixed to the transfer medium by a well-known heating and/or pressing fixing system such as a heat roller, and the transfer medium is discharged to the outside of the machine.

5. On the other hand, in the image forming units 23a to 23d, similarly to the example of the two-component development process of the paragraphs (1)6 to (1)8, the charges of the electrostatic latent image carriers 22a to 22d are removed, and return is made to the image formation process through cleaning and the like. In the developing sections 21a to 21d, the toner ratio density is adjusted at any time. Here, although the description is given to the example in which the image forming units are arranged in the order of yellow, magenta, cyan and black, the order of the colors is not limited.

Incidentally, when the transfer medium is the intermediate transfer medium 24, as shown in FIG. 5A, the secondary transfer section 26 transfers the toner images of the four colors collectively to the final transfer medium such as the fed paper 22. Thereafter, the paper 22 is conveyed to the fixing section 27. The fixing section 27 similarly fixes the toner images to the paper 22, and the paper 22 is discharged to the outside of the machine.

(5) Four-Drum Tandem Cleanerless Process

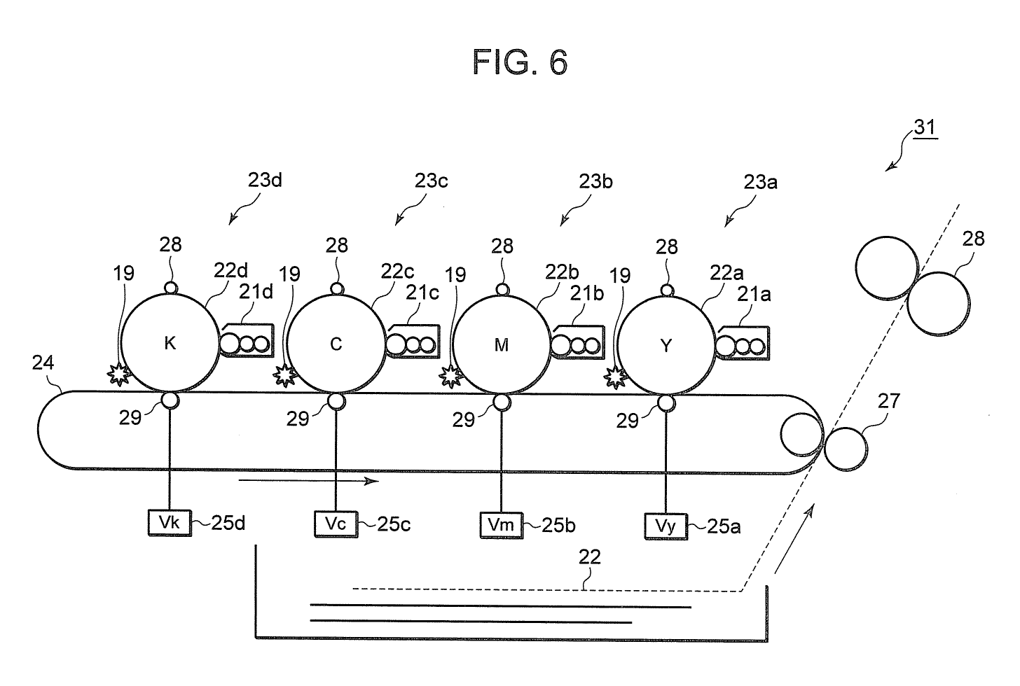

FIG. 6 is a schematic structural view of an image forming apparatus based on a four-drum tandem cleanerless process.

As shown in FIG. 6, an image forming apparatus 31 fixes toners of four colors onto a final transfer medium by a similar process to the foregoing cleanerless process. The image forming apparatus 31 is different from the tandem image forming apparatus 20 in that a device to clean the transfer residual toner on the electrostatic latent image carriers 22a to 22d and the reversely transferred toner is not provided. In the figure, the same reference numerals as the foregoing reference numerals denote the same components. The transfer residual toner and the reversely transferred toner are collected at the same time as the development without using a cleaning device.

The image forming apparatus 31 may include at least one of a memory disturbing member, a temporary collection member, and a toner charging device on electrostatic latent image carriers 22a to 22d as in the example of the above paragraph (3). One member may have also a function of at least one of the other members.

For example, the electrostatic latent image carrier 22a may include a not-shown lateral direction brush slide mechanism to perform all the three functions of the memory disturbing member, the temporary collection member and the toner charging device. The lateral direction means a direction parallel to a rotation shaft direction of the electrostatic latent image carrier 22a. The lateral direction brush slide mechanism includes two brush holders each of which is reciprocated in the lateral direction and two brushes (lateral slide brushes) provided in the respective brush holders. The two brushes are provided so that brush leading ends contact with the photoconductor at a position between the transfer region and the photoconductor charging member.

Each of the two brushes is made of many brush fibers. The roots of the respective brush fibers are along the longitudinal direction of the electrostatic latent image carrier 22a. The roots of the respective brush fibers are attached to the brush holder. The leading ends of the respective brush fibers contact with the outer peripheral surface of the electrostatic latent image carrier 22a. The two brushes are attached to the respective brush holders at positions separate from each other along the outer peripheral surface of the electrostatic latent image carrier 22a. The one brush is provided at the upstream side of the electrostatic latent image carrier 22a in the rotation direction. The other brush is provided at the downstream side of the electrostatic latent image carrier 22a in the rotation direction. The electrostatic latent image carriers 22b to 22d may also be provided with the same lateral direction drive mechanism as the lateral direction drive mechanism provided to the electrostatic latent image carrier 22a.

A voltage having the same polarity as the electric charge of the development toner is applied to the upstream side brush, and a voltage having a polarity different from the electric charge of the development toner is applied to the downstream side brush. In the transfer residual toner, the different polarity toner and the toner having the same polarity and a very large charge amount are mixed. When the different polarity toner contacts with the same polarity brush, the electric charge is reversed, and the toner passes through between the brush fibers or is once collected by the brush.

All the transfer residual toners that reach the downstream brush of the different polarity are given the same polarity as the polarity of the development toner. The electric charges of the many toner particles having different charge amounts are adjusted to a small value. The transfer residual toner contacts with the brush of the different polarity, so that the large charge amount of the same polarity is reduced, and the toner passes through between the brush fibers or is once collected by the brush.

The charge amounts of the transfer residual toners are adjusted. An image structure of the transfer residual toners is lost by the mechanical contact of the brush. The transfer residual toners, together with the electrostatic latent image carriers 22a to 22d, are charged by the contact or non-contact charging members of the electrostatic latent image carriers 22a to 22d.

The charge amount of the transfer residual toner is adjusted to substantially the same level as the charge amount of the development toner. Since the charge amount is adjusted, the transfer residual toner in a non-image part of a new latent image in the development region is collected in the developing section 23. The transfer residual toner in an image part, together with the toner newly supplied from the developing section 23, is transferred to the transfer medium. In this way, the charge amount of the transfer residual toner is adjusted and the toner is collected in the developing section 23.

In the four-drum tandem machine, when the toner of the former stage color is reversely transferred to the electrostatic latent image carrier, the reversely transferred toner, together with the toner of the later stage color, is collected by the developing section at the later stage. Since the reversely transferred toner is collected, there arises a problem that when the amount of reverse transfer is large, the tint of the toner in the developing section 23 is changed. However, since the amount of reverse transfer is suppressed to be very small by using the developer of the color image forming apparatus of the embodiment, the problem of the color mixture does not occur.

Simultaneously, when the amount of residual transfer is large, the amount of toner temporarily collected by the memory disturbing brush becomes large, and the process of discharging the toner from the brush to the electrostatic latent image carrier is frequently required. Alternatively, the capability to strongly discharge the toner is required. There is a fear that a specified function can not be performed.

Since the amount of transfer residual toner can be made very small by using the developer of the color image forming apparatus of the embodiment, the amount of toner temporarily collected by the memory disturbing brush can also be made small. The discharge of toner from the brush becomes easy. It is possible to keep the cleanerless process while high picture quality is kept for a long period of time.

When the contact-type charging device of the electrostatic latent image carrier is used, there is obtained an effect of preventing the ozone deterioration of the photoconductor photoconductive layer and prolonging the life of the photoconductor. The charging device uses a charging roller that includes at least an elastic layer of, for example, ion conductive rubber or carbon dispersed rubber and has a volume resistance of about 10̂4 to 10̂8 Ωcm.

The charging device causes the charging roller to contact with the photoconductor at constant pressure and to rotate integrally with the photoconductor. Alternatively, the charging device causes the charging roller to rotate at the same peripheral speed as the peripheral speed of the photoconductor or a peripheral speed slightly different from the peripheral speed of the photoconductor. The charging device applies a DC voltage of 400 to 1000 V to the shaft of the charging roller, so that an electric charge is injected to the surface of the photoconductor, and the photoconductor is charged to a specified potential.

In the cleanerless process, there is a possibility that transfer residual toner remains on the photoconductor when the photoconductor is charged. In the cleanerless tandem system, there is a possibility that in addition to the transfer residual toner, reversely transferred toner remains on the photoconductor when the photoconductor is charged. Thus, a web, a brush, a blade or the like for cleaning the charging roller may always or suitably contact with the photoconductor.

Hereinafter, toner used in the embodiment will be described.

With respect to a toner production method, a description will be given to a case where the order of transfer is yellow, magenta, cyan and black. This order is not particularly limited.

### EXAMPLE 1 OF TONER IN WHICH ADHESIVE FORCE IS CHANGED

### (1) Yellow Toner

Polyester resin 28 wt. parts, yellow pigment 7 wt. parts, rice wax 5 wt. parts, and carnauba wax 1 wt. part are kneaded by Kneadex made by YPK and a master batch is formed. After the master batch is coarsely pulverized, polyester resin 58 wt. parts and CCA (TN105 made by Hodogaya Chemical Co., Ltd.) 1 wt. part are added thereto and are kneaded.

The resultant structure is coarsely pulverized and is finely pulverized, and particles having a particle diameter of 7 μm or more and particles having a particle diameter of 3 μm or less are cut out by an elbow jet classification, so that colored resin particles having an average particle diameter of 5.3 μm are obtained. For the colored resin particle 100 wt. parts, silica 3 wt. parts (NAX50 made by NIPPON AEROSIL Co., Ltd.) having an average particle diameter of 30 nm, and titanium oxide 1.2 wt. parts (NKT90 made by Titan Kogyo, Ltd.) are adhered to the surface of the particle by using Henschel mixer. The circularity of obtained toner particles is 0.92.

The resultant toner particles are mixed with carriers of spherical ferrite particles having a volume average particle diameter of 40 μm and coated with silicone resin, so that a developer is prepared. The charge amount Q/M of toner is −30 μC/g. An electrostatic latent image on a photoconductor is developed with a toner layer of about 250 μg/cm² and the charge amount of the toner is measured by sucking the toner by a suction type charge amount measuring apparatus (Model 210HS-2 made by TREK). Besides, an electrostatic latent image on a photoconductive sheet is developed with the same amount of toner and the adhesive force is measured by using a super centrifugal machine.

### (2) Magenta Toner

Polyester resin 28 wt. parts, Carmine 6B 7 wt. parts, rice wax 5 wt. parts, and carnauba wax 1 wt. part are kneaded by Kneadex made by YPK and a master batch is formed. After the master batch is coarsely pulverized, polyester resin 58 wt. parts and CCA (TN105 made by Hodogaya Chemical Co., Ltd.) 1 wt. part are added thereto and are kneaded.

The resultant structure is coarsely pulverized and is finely pulverized, and particles having a particle diameter of 7 μm or more and particles having a particle diameter of 3 μm or less are cut out by an elbow jet classification, so that colored resin particles having an average particle diameter of 5.3 μm are obtained. The colored resin fine particle 100 wt. parts and silica 1 wt. part (NAX50 made by NIPPON AEROSIL Co., Ltd.) having an average particle diameter of 30 nm are simultaneously put into a mechano-fusion apparatus (made by Hosokawa Micron Corporation), and are processed at 200° C., so that slightly sphered colored resin fine particles are obtained.

For the sphered colored resin particle 100 wt. parts, silica 2 wt. parts (NAX50 made by NIPPON AEROSIL Co., Ltd.) having an average particle diameter of 30 nm, and titanium oxide 1.2 wt. parts (NKT90 made by Titan Kogyo, Ltd.) are adhered to the surface of the particle by using Henschel mixer. The average circularity of obtained toner particles is 0.94.

The resultant toner particles are mixed with carriers of spherical ferrite particles having a volume average particle diameter of 40 μm and coated with silicone resin, so that a developer is prepared. The charge amount Q/M of toner is −33 μC/g. An electrostatic latent image on a photoconductor is developed with a toner layer of about 250 μg/cm² and the charge amount of the toner is measured by sucking the toner by the suction type charge amount measuring apparatus (Model 210HS-2 made by TREK) Besides, an electrostatic latent image on a photoconductive sheet is developed with the same amount of toner and the adhesive force is measured by using the super centrifugal machine.

### (3) Cyan Toner

Polyester resin 28 wt. parts, phthalocyanine blue 7 wt. parts, rice wax 5 wt. parts, and carnauba wax 1 wt. part are kneaded by Kneadex made by YPK and a master batch is formed. After the master batch is coarsely pulverized, polyester resin 58 wt. parts and CCA (TN105 made by Hodogaya Chemical Co., Ltd.) 1 wt. part are added thereto and are kneaded.

The resultant structure is coarsely pulverized and is finely pulverized, and particles having a particle diameter of 7 μm or more and particles having a particle diameter of 3 μm or less are cut out by an elbow jet classification, so that colored resin particles having an average particle diameter of 5.3 μm are obtained. The colored resin fine particle 100 wt. parts and silica 1 wt. part (NAX50 made by NIPPON AEROSIL Co., Ltd.) having an average particle diameter of 30 nm are simultaneously put into the mechano-fusion apparatus (made by Hosokawa Micron Corporation), and are processed at 200° C., so that slightly sphered colored resin fine particles are obtained.

For the sphered colored resin particle 100 wt. parts, silica 2 wt. parts (NAX50 made by NIPPON AEROSIL Co., Ltd.) having an average particle diameter of 12 nm, and titanium oxide 1.2 wt. parts (NKT90 made by Titan Kogyo, Ltd.) are adhered to the surface of the particle by using Henschel mixer. The average circularity of obtained toner particles is 0.96.

The resultant toner particles are mixed with carriers of spherical ferrite particles having a volume average particle diameter of 40 μm and coated with silicone resin, so that a developer is prepared. The charge amount Q/M of toner is −32 μC/g. An electrostatic latent image on a photoconductor is developed with a toner layer of about 250 μg/cm² and the charge amount of the toner is measured by sucking the toner by the suction type charge amount measuring apparatus (Model 210HS-2 made by TREK). Besides, an electrostatic latent image on a photoconductive sheet is developed with the same amount of toner and the adhesive force is measured by using the super centrifugal machine.

### (4) Black Toner

Polyester resin 28 wt. parts, carbon black 7 wt. parts, rice wax 5 wt. parts, and carnauba wax 1 wt. part are kneaded by Kneadex made by YPK and a master batch is formed. After the master batch is coarsely pulverized, polyester resin 58 wt. parts and CCA (TN105 made by Hodogaya Chemical Co., Ltd.) 1 wt. part are added thereto and are kneaded.

The resultant structure is coarsely pulverized and is finely pulverized, and particles having a particle diameter of 7 μm or more and particles having a particle diameter of 3 μm or less are cut out by an elbow jet classification, so that colored resin particles having an average particle diameter of 5.3 μm are obtained.

The colored resin fine particle 100 wt. parts and silica 1 wt. part (NAX50 made by NIPPON AEROSIL Co., Ltd.) having an average particle diameter of 30 nm are simultaneously put into the mechano-fusion apparatus (made by Hosokawa Micron Corporation) and are processed at 200° C., so that slightly sphered colored resin fine particles are obtained. For the sphered colored resin particle 100 wt. parts, silica 2 wt. parts (NAX50 made by NIPPON AEROSIL Co., Ltd.) having an average particle diameter of 30 nm, and titanium oxide 1.2 wt. parts (NKT90 made by Titan Kogyo, Ltd.) are adhered to the surface of the particle by using Henschel mixer. The average circularity of obtained toner particles is 0.975.

The resultant toner particles are mixed with carriers of spherical ferrite particles having a volume average particle diameter of 40 μm and coated with silicone resin, so that a developer is prepared. The charge amount Q/M of toner is −31 μC/g. Besides, an electrostatic latent image on a photoconductive sheet is developed with the same amount of toner and the adhesive force is measured by using the super centrifugal machine.

TABLE 1

| | | Y | M | C | K |
|---|---|---|---|---|---|
| external | NAX50 (30 nm) | 3% | 3% | 3% | 3% |
| addition | NKT90 | 1.20% | 1.20% | 1.20% | 1.2% |
| 50% volume average particle | | 5.3 | 5.3 | 5.3 | 5.3 |
| diameter [μm] | | | | | |
| circularity | | 0.92 | 0.94 | 0.96 | 0.975 |
| adhesive force | Ke [N/C\hat{ }2)] | 4.6E+21 | 4.1E+21 | 4.9E+21 | 5.6E+21 |
| characteristic | F0 [N] | 3.4E−08 | 3.0E−08 | 1.65E−08 | 5.9E−09 |

| | | | | |
|---|---|---|---|---|
| charge amount Q/M [μC/g] | −30 | −33 | −32 | −31 |
| adhesive force [N] | 6.83E−08 | 6.69E−08 | 6.16E−08 | 5.96E−08 |
| required transfer electric | 2.5E+07 | 2.2E+07 | 2.0E+07 | 1.9E+07 |
| field [V/m] | | | | |

The adhesive force characteristic is obtained in a manner as described below. The mixing ratio of the toner and the carrier is changed and the toner charge amount is changed, so that the average adhesive force of each of the toner and the carrier is measured. The square of a charge amount per one toner particle (the particle is regarded as a true sphere having a 50% volume average particle diameter, the specific gravity is 1.2, and the weight and charge amount per one particle are converted) is taken as the x-axis, and the adhesive force to the charge amount per one toner particle is taken as the y-axis, and plotting is performed.

Incidentally, E and a numeral subsequent to E denote the exponentiation of 10. Ĉ2 denotes the square of C.

The inclination of an approximated straight line of the respective plotted values is Ke[N/(Ĉ2)], and the Y intercept is F₀[N]. The required transfer electric field is a value obtained by dividing the adhesive force by the electric charge amount of one toner particle ([V/m]=[N/C]).

When the peripheral length of a particle calculated from a projected area of the particle and a diameter of a perfect circle having the equal area is D1, and the peripheral length of the projected particle is D2, the circularity of the particle is calculated from circularity=D1/D2. In the case of the perfect circle (=perfect sphere), the circularity is 1. The circularity of a toner particle is measured using a flow particle image analyzer FPIA-3000 made by SYSMEX CORPORATION.

The developers of the above paragraphs (1) to (4) are respectively put in the monochromatic printing apparatus of FIG. 3, and the transfer characteristics are measured. The optimum transfer bias voltages of the respective colors are as follows: yellow, 1200 v; magenta, 1100 v; cyan, 1000 v; and black, 900 v.

The developers of these colors are put in the four-drum tandem full color printing apparatus 20 of FIG. 5A or the four-drum tandem full color printing apparatus 20A of FIG. 5B so that they are transferred to the transfer belt in the order of yellow, magenta, cyan and black. This apparatus is operated at a process speed of 127 mm/sec. The transfer bias voltages of the respective colors are standardized to 1200 v. In any combination of the colors, an excellent transfer characteristic that a transfer efficiency of 97% or more is kept is obtained.

### EXAMPLE 2 OF TONER IN WHICH ADHESIVE FORCE IS CHANGED

Polyester resin 28 wt. parts, each color pigment 7 wt. parts, rice wax 5 wt. parts, and carnauba wax 1 wt. part are kneaded by Kneadex made by YPK and a master batch is formed. After the master batch is coarsely pulverized, polyester resin 58 wt. parts and CCA (TN105 made by Hodogaya Chemical Co., Ltd.) 1 wt. part are added thereto and are kneaded.

The resultant structure is coarsely pulverized and is finely pulverized, and particles having a particle diameter of 7 μm or more and particles having a particle diameter of 3 μm or less are cut out by an elbow jet classification, so that colored resin particles having an average particle diameter of 5.8 μm is obtained. For the colored resin particle 100 wt. parts, external additives listed in Table 2 described below are respectively adhered to the surface of the particle by using Henschel mixer. The circularity of obtained toner particles is 0.93.

The resultant toner particles are mixed with carriers of spherical ferrite particles having a volume average particle diameter of 40 μm and coated with silicone resin at a toner particle ratio of 7 wt. parts, so that a developer is prepared. The toner charge amount is measured. An electrostatic latent image on a photoconductor is developed with a toner layer of about 250 μg/cm² and the charge amount is measured by sucking the toner by the suction type charge amount measuring apparatus (Model 210HS-2 made by TREK). Besides, an electrostatic latent image on a photoconductive sheet is developed with the same amount of toner and the adhesive force is measured by using the super centrifugal machine.

TABLE 2

| | | Y | M | C | K |
|---|---|---|---|---|---|
| external | RX200 (12 nm) | 1.50% | 1.30% | 1.15% | 1.00% |
| addition | large particle | 1.50% | 2% | 2.50% | 3% |
| | diameter silica (100 nm) | | | | |
| | NKT90 | 1% | 1% | 1% | 1% |
| 50% volume average particle | | 5.8 | 5.8 | 5.8 | 5.8 |
| diameter [μm] | | | | | |
| adhesive force | Ke [N/C\hat{ }2)] | 2.80E+21 | 2.90E+21 | 2.70E+21 | 3.10E+21 |
| characteristic | F0 [N] | 7.10E−08 | 6.00E−08 | 4.50E−08 | 1.30E−08 |

| | | | | |
|---|---|---|---|---|
| charge amount Q/M [μC/g] | −34 | −33 | −32 | −34 |
| adhesive force [N] | 1.20E−07 | 1.07E−07 | 8.60E−08 | 6.60E−08 |
| required transfer electric | 2.90E+07 | 2.60E+07 | 2.20E+07 | 1.60E+07 |
| field [V/m] | | | | |

As stated above, the adhesive force is obtained in a relative relation of Y>M>C>K.

These developers are put in the four-drum tandem full color printing apparatus 20 of FIG. 5A or the four-drum tandem full color printing apparatus 20A of FIG. 5B so that they are transferred to the transfer belt in the order of yellow, magenta, cyan and black. This apparatus is operated at a process speed of 252 mm/sec. The transfer bias voltages of the respective colors are standardized to 1400 v.

In any combination of the colors, an excellent transfer characteristic that a transfer efficiency of 98% or more is kept is obtained.

### EXAMPLE 3 OF TONER IN WHICH ADHESIVE FORCE IS CHANGED

Polyester prepolymer is dissolved in an organic solvent. Wax, pigment, and polymerization initiator are dispersed in a solution, and the solvent is put into an aqueous solvent and is emulsified. Heating is performed while agitation is performed, so that fine resin particles including the wax and the pigment and having a uniform particle diameter distribution are produced.

Prepolymer is additionally added into the solvent to polymerize the fine particles so as to be packed into capsules, and then, the solvent of the resultant capsules is removed, and they are dried and taken out, so that sharp colored particles having a particle distribution of toner particles of a volume average particle diameter of 5.6 μm are obtained. The circularity of the particles is 0.95.

For the colored resin particle 100 wt. parts, silica 2.5 wt. parts (NAX50 made by NIPPON AEROSIL Co., Ltd.) having an average particle diameter of 30 nm, large particle diameter silica 1 wt. part having an average particle diameter of 100 nm, and titanium oxide 1 wt. part (NKT90 made by Titan Kogyo, Ltd.) are adhered to the surface by using Henschel mixer. The toner particles are mixed with carriers A which are spherical ferrite particles having a volume average particle diameter of 40 μm and in which 80% or more of the surface is coated with silicone resin or carriers B in which 100% or more of the surface is coated with silicon resin, so that a developer is prepared. The toner charge amount is measured.

The charge amount is measured such that an electrostatic latent image on a photoconductor is developed with a toner layer of about 250 μg/cm², and is sucked by the suction type charge amount measurement apparatus (Model 210HS-2 made by TREK). The adhesive force is measured such that an electrostatic latent image on a photoconductive sheet is developed with the same amount of toner and the super centrifugal machine is used.

### (1) Yellow Toner

Mixing is performed at a ratio of 8.5 wt. parts of the toner particle to 91.5 wt. parts of the carrier particle A, and a developer is formed. The developer is put into the first developing section 21a of FIG. 5A or FIG. 5B. The charge amount of the developed toner is measured by the above method, and is −25 μC/g. The adhesive force and the required transfer electric field are as shown in Table 3 described below.

### (2) Magenta Toner

Mixing is performed at a ratio of 7 wt. parts of the toner particle to 93 wt. parts of the carrier particle A, and a developer is formed. The developer is put into the second developing section 21b of FIG. 5A or FIG. 5B. The charge amount of the developed toner is measured by the above method, and is −30 μC/g. The adhesive force and the required transfer electric field are as shown in Table 3 described below.

### (3) Cyan Toner

Mixing is performed at a ratio of 5.5 wt. parts of the toner particle to 94.5 wt. parts of the carrier particle A, and a developer is formed. The developer is put into the third developing section 21c of FIG. 5A or FIG. 5B. The charge amount of the developed toner is measured by the above method, and is −40 μC/g. The adhesive force and the required transfer electric field are as shown in Table 3 described below.

### (4) Black Toner

Mixing is performed at a ratio of 6 wt. parts of the toner particle to 94 wt. parts of the carrier particle B, and a developer is formed. The developer is put into the fourth developing section 21d of FIG. 5A or FIG. 5B. The charge amount of the developed toner is measured by the above method, and is −50 μC/g. The adhesive force and the required transfer electric field are as shown in Table 3 described below.

TABLE 3

| | | Y | M | C | K |
|---|---|---|---|---|---|
| external | NAX50 (30 nm) | 2.50% | 2.50% | 2.50% | 2.50% |
| addition | large particle | 1% | 1% | 1% | 1% |
| | diameter silica | | | | |
| | (100 nm) | | | | |
| | NKT90 | 1% | 1% | 1% | 1% |
| 50% volume average particle | | 5.6 | 5.6 | 5.6 | 5.6 |
| diameter [μm] | | | | | |
| adhesive force | Ke [N/C\hat{ }2)] | 9.6E+19 | 9.6E+19 | 9.6E+19 | 9.6E+19 |
| characteristic | F0 [N] | 6.0E−08 | 6.0E−08 | 6.0E−08 | 6.0E−08 |

| | | | | |
|---|---|---|---|---|
| charge amount Q/M [μC/g] | −25 | −30 | −40 | −50 |
| adhesive force [N] | 6.78E−08 | 7.10E−08 | 7.92E−08 | 8.97E−08 |
| required transfer electric | 2.5E+07 | 2.2E+07 | 1.8E+07 | 1.6E+07 |
| field [V/m] | | | | |

As in Table 3, a set of toners of four colors is obtained which has a relative relation of Y<M<C<K in the charge amount and Y>M>C>K in the required transfer electric field.

These developers are put in the four-drum tandem full color printing apparatus 20 of FIG. 5A or the four-drum tandem full color printing apparatus 20A of FIG. 5B. The apparatus is operated at a process speed of 127 mm/sec. The transfer bias voltages of the respective colors are standardized to 1000 v.

In all the four colors, a self-transfer efficiency of 98% or more which is higher than that of the related art is obtained, and the amount of reverse transfer is smaller than that of the related art. In secondary transfer, in any combination of the colors, a secondary transfer efficiency of 96% or more which is higher than that of the related art is obtained.

Besides, the toner sets of the examples 1 to 3 are put into the four-drum tandem cleanerless printing apparatus 31 of FIG. 6. A life test is performed in which a natural picture having an average print ratio of about 20% for each color is printed on 100 K sheets.

Since both the amount of remaining transfer and the amount of reverse transfer are small, there does not occur an image memory such as a negative memory and a positive memory due to defective collection of transfer residual toner and reverse transfer toner. Besides, there does not occur a defect, such as a change of color reproducibility or color matching impossibility, which is caused when the reverse transfer toner is collected in a developing section of a different color and is mixed. Further, since a secondary transfer efficiency is also high, the amount of waste toner collected by a cleaning device of transfer residual toner on a not-shown transfer belt is also very small.

5. Effects of the Color Image Forming Method and the Color Image Forming Apparatus of the Embodiment

In order to move the toner particle by the electric field, it is necessary that the force of the electric field is larger than the adhesive force. When the magnitude of the electric field is E, the adhesive force between the toner and the photoconductor is F, and the charge amount of the toner is q, since the force applied to the toner from the electric field is expressed by qE, the required transfer electric field is E>F/q. Among particles whose particle diameters and charge amounts are substantially equal to one another, as the adhesive force becomes small, the required transfer electric field E becomes small.

In the image formation process of the tandem structure, since toners of the respective colors are superposed and transferred onto the intermediate transfer medium or the final transfer medium in a non-fixed state, there arises a problem that the previously transferred toner is reversely transferred to the electrostatic latent image carrier at a transfer nip of a next color and the following colors. Thus, at the transfer nip of the second color and the following colors, it is necessary to establish the transfer condition so that the reverse transfer does not occur. There is no such anxiety for the first color.

Then, the adhesive force of the toner of the second color and the following colors is made smaller than the adhesive force of the toner of the first color, so that it is possible to find the transfer condition under which a sufficient self-transfer efficiency can be obtained without generating the reverse transfer.

In the case of the image formation process of the tandem structure using toners of three or more colors, a semiconductive member is used as the intermediate transfer belt or the transfer belt of the final transfer medium of the direct transfer system. The belt and/or the already transferred toner is charged up by the transfer electric field, and when the same transfer bias voltage is applied, there arises a problem that as the transfer position becomes a later stage in the medium conveyance direction, the applied electric field becomes small.

However, when toners of plural colors having substantially equal particle diameters and charge amounts are used, when the toner adhesive force is made small as the transfer position becomes a later stage in the medium conveyance direction, the required transfer electric field also becomes small, and the high transfer efficiency can be kept for all the colors.

In the image formation process of the tandem structure, it is not necessary to consider the reverse transfer for the first color toner. Besides, since the transfer belt is not charged up, there is a tendency that the transfer electric field to the toner of the first color is applied more intensely than the transfer electric field to the toner of the second color and the following colors. When the transfer electric field is applied intensely, the charge amount of the toner is increased or decreased by the influence of electric discharge generated between the toner at the nip inlet and/or outlet and the photoconductor.

Then, the charge amount of the toner of the first color is previously set to be small, and it is suppressed that the charge amount of the toner which is positioned at a later stage than the position where the first color toner is transferred and is to be transferred is changed excessively. At the secondary transfer, the difference between the toner charge amount of the former stage where the charge amount is changed and the toner charge amount by only the self transfer at the later stage is made small, so that the difference of transfer efficiency due to color can be eliminated.

In the image formation process of the tandem structure using toners of three or more colors, when the toner charge amount is made high as the position of transfer becomes later, the charge amount of the toner of the transfer medium can become high as the number of times that the transfer medium passes through the transfer nip becomes large. According to the image forming apparatus of the embodiment, it is prevented that the charge amount of the toner on the transfer medium at the latter stage becomes high, and the difference of the transfer efficiency due to color in the secondary transfer can be made smaller.

When the transfer electric field E applied to the toner is larger than F/q, the toner is transferred. The adhesive force F is expressed by the sum of the electrostatic adhesive force Fe and the non-electrostatic adhesive force Fo. The electrostatic adhesive force Fe is proportional to the square of the toner charge amount q. Since the adhesive force F has the square term of the toner charge amount q, the magnitude of the required transfer electric field with respect to the toner charge amount has a minimum value. As the charge amount becomes large, there is a region of q where the required transfer electric field becomes small.

Accordingly, in the color image formation process by the tandem structure, it is necessary to design the required transfer electric field for each color in view of not only the toner charge amount but also the adhesive force characteristic. For the toners of the second color and the following colors, consideration must be made so as to increase the self-transfer efficiency and to decrease the reverse transfer. When the required transfer electric field F/q of the second color and the following colors is smaller than the required transfer electric field F/q of the first color, the transfer condition of the second color and the following colors can be set to such a transfer condition that the self transfer has high efficiency and the reverse transfer does not occur.

Since the semiconductive transfer belt is used, in a region where the belt is charged up each time the transfer voltage is applied to the belt, or toner must be transferred to be superposed on the toner transferred at the former stage, the electric field becomes hard to be applied to the belt by the influence of the increase of the distance between the electrodes by the already transferred toner at the transfer nip, the existence of high resistance material, the potential by the electric charge of the already transferred toner itself, and the like. Since the electric charge becomes hard to be applied to the belt, when the required transfer electric fields of toners of all colors are equal to one another, or when the required transfer electric field of toner at a latter stage is higher than the required transfer electric field of toner at a former stage, as the position of transfer becomes a latter stage, the transfer becomes hard to occur. However, when the required transfer electric field F/q becomes small as the transfer position becomes a latter stage, high transfer efficiency can be kept for toners of any color without generating the reverse transfer.

When toner is secondarily transferred to the intermediate transfer medium, when the charge amounts of toner on the intermediate transfer medium are irregular, an excellent secondary transfer characteristic can not be obtained. When the charge amount of toner is made large as the position of transfer of the toner becomes a latter stage, it is possible to eliminate a difference in charge amount between the former stage toner whose charge amount is increased since the toner passes through a transfer nip and the final stage toner of only the self transfer.

Since the difference between the charge amount of the final stage toner and the charge amount of the previous stage toner is eliminated, the secondary transfer efficiency can also be kept excellently without being changed by color. When the difference between the charge amount of the final stage toner and the charge amount of the previous stage toner is eliminated, the adhesive force characteristic is designed so that as the transfer position becomes a latter stage, the required transfer electric field F/q becomes small. Consequently, the self transfer and reverse transfer characteristics can be excellently kept for the respective colors.

In the cleanerless process, when the image forming apparatus superposes plural colors directly or on the intermediate transfer medium, in the toner transfer region on the electrostatic latent image carrier of each of the image forming units of the second color and the following colors, the toner transferred by the image transfer unit at the former stage is reversely transferred. Since there is no cleaner, the reversely transferred toner of a different color, together with the transfer residual toner, is collected in the developing section of the image transfer unit at the next stage.

When the number of prints is increased, the amount of toner collected after the reverse transfer is also increased, the colors of the toners are mixed in the developing section of the image forming unit at the latter stage, and the color adjustment becomes impossible. However, when the toner used in the image forming apparatus of the embodiment and the transfer process are used, the amount of reverse transfer can be decreased, and the color mixture can be prevented.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen within the scope of the present invention.

What is claimed is:

1. A color image forming method in which there are provided a plurality of image forming sections each including an image carrier, a toner image forming section to form a monochromatic toner image on the image carrier by using monochromatic toner particles, and a transfer section to transfer the monochromatic toner image formed on the image carrier onto a transfer target medium, and a conveyance section to convey the transfer target medium along an arrangement direction of the plurality of image forming sections, and toner images of a plurality of colors are transferred to the transfer target medium to form a color image on the transfer target medium, wherein:
when a weight per particle of the respective monochromatic toner particles calculated from a 50% volume average particle diameter of the respective monochromatic toner particles is m (kg), a charge amount per particle of the respective monochromatic toner particles calculated from a charge amount Q/M (C/kg) per weight measured by a suction type particle charge amount measuring device is q (C), and an average adhesive force between each of the monochromatic toner particles and each of the image carriers is F (N),
F/q of the toner particle used in the image forming section in which order in transferring the monochromatic toner image to the transfer target medium is the first in the plurality of image forming sections is largest.

2. The method of claim 1, wherein
as the order becomes late, the transfer section transfers the toner particle having smaller F/q to the transfer target medium.

3. The method of claim 1, wherein
a process of image formation for forming the color image on the transfer target medium adopts a cleanerless process.

4. The method of claim 2, wherein
a process of image formation for forming the color image on the transfer target medium adopts a cleanerless process.

5. A color image forming method in which there are provided a plurality of image forming sections each including an image carrier, a toner image forming section to form a monochromatic toner image on the image carrier by using monochromatic toner particles, and a transfer section to transfer the monochromatic toner image formed on the image carrier onto a transfer target medium, and a conveyance section to convey the transfer target medium along an arrangement direction of the plurality of image forming sections, and toner images of a plurality of colors are transferred to the transfer target medium to form a color image on the transfer target medium, wherein:
an adhesive force of the toner particle used in the image forming section in which order in transferring the monochromatic toner image to the transfer target medium is the first in the plurality of image forming sections is largest.

6. The method of claim 5, wherein
as the order becomes late, the transfer section transfers the toner particle having a smaller adhesive force to the transfer target medium.

7. The method of claim 5, wherein
a process of image formation for forming the color image on the transfer target medium adopts a cleanerless process.

8. A color image forming method in which there are provided a plurality of image forming sections each including an image carrier, a toner image forming section to form a monochromatic toner image on the image carrier by using monochromatic toner particles, and a transfer section to transfer the monochromatic toner image formed on the image carrier onto a transfer target medium, and a conveyance section to convey the transfer target medium along an arrangement direction of the plurality of image forming sections, and toner images of a plurality of colors are transferred to the transfer target medium to form a color image on the transfer target medium, wherein:
a charge amount of the toner particle used in the image forming section in which order in transferring the monochromatic toner image to the transfer target medium is the first in the plurality of image forming sections is smallest.

9. The method of claim 8, wherein
as the order becomes late, the transfer section transfers the toner particle having a larger charge amount to the transfer target medium.

10. The method of claim 8, wherein
a process of image formation for forming the color image on the transfer target medium adopts a cleanerless process.

11. A color image forming apparatus for forming a color image on a transfer target medium by transferring toner images of a plurality of colors to the transfer target medium, comprising:
a plurality of image carriers;
a plurality of toner image forming sections each of which forms a monochromatic toner image on each of the image carriers by using monochromatic toner particles;
a plurality of transfer sections each of which transfers the monochromatic toner image formed on each of the image carriers to the transfer target medium;
a bias voltage application section to apply to each of the transfer sections a bias voltage of a polarity for exerting a force to the respective toner particles in a direction from each of the image carriers to the transfer target medium; and
a conveyance section to convey the transfer target medium along an arrangement direction of the plurality of image forming sections, wherein
when a weight per particle of the respective monochromatic toner particles calculated from a 50% volume average particle diameter of the respective monochromatic toner particles is m (kg), a charge amount per particle of the respective monochromatic toner particles calculated from a charge amount Q/M (C/kg) per weight measured by a suction type particle charge amount measuring device is q (C), and an average adhesive force between each of the monochromatic toner particles and each of the image carriers is F (N),
the transfer section of the plurality of transfer sections positioned at the most upstream side in the arrangement direction transfers the toner particle having largest F/q in the toner particles of the plurality of colors to the transfer target medium.

12. The apparatus of claim 11, wherein
a transfer section of the plurality of transfer sections positioned at a latter stage in the arrangement direction transfers a toner particle having smaller F/q to the transfer target medium.

13. The apparatus of claim 11, wherein
the plurality of image carriers use a cleanerless mechanism that does not include a cleaning device to remove and discard toner particles remaining on the respective image carriers.

14. The apparatus of claim 12, wherein
the plurality of image carriers use a cleanerless mechanism that does not include a cleaning device to remove and discard toner particles remaining on the respective image carriers.

15. A color image forming apparatus for forming a color image on a transfer target medium by transferring toner images of a plurality of colors to the transfer target medium, comprising:
a plurality of image carriers;
a plurality of toner image forming sections each of which forms a monochromatic toner image on each of the image carriers by using monochromatic toner particles;
a plurality of transfer sections each of which transfers the monochromatic toner image formed on each of the image carriers to the transfer target medium;
a bias voltage application section to apply to each of the transfer sections a bias voltage of a polarity for exerting a force to the respective toner particles in a direction from each of the image carriers to the transfer target medium; and
a conveyance section to convey the transfer target medium along an arrangement direction of the plurality of image forming section, wherein
the transfer section of the plurality of transfer sections positioned at the most upstream side in the arrangement direction transfers the toner particle having a largest adhesive force in the toner particles of the plurality of colors to the transfer target medium.

16. The apparatus of claim 15, wherein
a transfer section of the plurality of transfer sections positioned at a latter stage in the arrangement direction transfers a toner particle having a smaller adhesive force to the transfer target medium.

17. The apparatus of claim 15, wherein
the plurality of image carriers use a cleanerless mechanism that does not include a cleaning device to remove and discard toner particles remaining on the respective image carriers.

18. A color image forming apparatus for forming a color image on a transfer target medium by transferring toner images of a plurality of colors to the transfer target medium, comprising:
a plurality of image carriers;
a plurality of toner image forming sections each of which forms a monochromatic toner image on each of the image carriers by using monochromatic toner particles;
a plurality of transfer sections each of which transfers the monochromatic toner image formed on each of the image carriers to the transfer target medium;
a bias voltage application section to apply to each of the transfer sections a bias voltage of a polarity for exerting a force to the respective toner particles in a direction from each of the image carriers to the transfer target medium; and
a conveyance section to convey the transfer target medium along an arrangement direction of the plurality of image forming units, wherein
the transfer section of the plurality of transfer sections positioned at the most upstream side in the arrangement direction transfers a toner particle having a smallest charge amount in the toner particles of the plurality of colors to the transfer target medium.

19. The apparatus of claim 18, wherein
a transfer section of the plurality of transfer sections positioned at a latter stage in the arrangement direction transfers a toner particle having a larger charge amount to the transfer target medium.

20. The apparatus of claim 18, wherein
the plurality of image carriers use a cleanerless mechanism that does not include a cleaning device to remove and discard toner particles remaining on the respective image carriers.
